(19) United States
(12) Patent Application Publication
(10) Pub. No.: US 2007/0047595 A1
(43) Pub. Date: Mar. 1, 2007

(54) Spectrum broadening and recompression in high-energy fiber laser system

(75) Inventors: Jian Liu, Sunnyvale, CA (US); Jiangfan Xia, Santa Clara, CA (US)

Correspondence Address: Bo-In Lin, 13445 Mandoli Drive, Los Altos Hills, CA, 94022, US

(73) Assignee: PolarOnyx, Inc.

(21) Appl. No.: 11/512,554

(22) Filed: Aug. 29, 2006

Related U.S. Application Data
(60) Provisional application No. 60/713,650, filed on Aug. 29, 2005.
(60) Provisional application No. 60/713,653, filed on Aug. 29, 2005.
(60) Provisional application No. 60/713,654, filed on Aug. 29, 2005.
(60) Provisional application No. 60/714,468, filed on Sep. 1, 2005.
(60) Provisional application No. 60/714,570, filed on Sep. 7, 2005.

(51) Int. Cl. H01S 3/30; H01S 3/098

(52) U.S. Cl. 372/6; 372/700; 372/18

(57) ABSTRACT

A fiber Chirped Pulse Amplification (CPA) laser system includes a fiber mode-locking oscillator for generating a laser for projecting to a fiber stretcher for stretching a pulse width of the laser. The fiber CPA laser further includes a multistage amplifier for amplifying the laser for projecting into a pulse shaper then to a compressor having a nonlinear phase generator for compensating high order dispersions and compressing the pulse width of the laser. The pulse shaper is further provided to minimize a nonlinear phase shift inside the multistage amplifier for reducing a Stimulated Raman Scattering (SRS

This Formal Application claims a Priority Date of Aug. 29, 2005 benefited from a Provisional Patent Application 60/713,650, 60/713,653, and 60/713,654 and a Priority Date of Sep. 1, 2005 benefited from Provisional Application 60/714,468 and 60/714,570 filed by one of the same Applicants of this Application.

### FIELD OF THE INVENTION

The present invention relates generally to apparatuses and methods for providing fiber laser system. More particularly, this invention relates a system configuration for spectrum broadening and pulse width recompression for correcting the third order dispersions (TOD) in a Chirped Pulse Amplification (CPA) fiber laser system.

### BACKGROUND OF THE INVENTION

Even though current technologies of fiber laser have made significant progress toward achieving a compact and reliable fiber laser system providing high quality output laser with ever increasing output energy, however those of ordinary skill in the art are still confronted with technical limitations and difficulties. Specifically, in a fiber laser system implemented with the Chirped Pulse Amplification (CPA) for short pulse high power laser amplifier, the CPA systems are still limited by the technical difficulties that the third order dispersion (TOD) limits the scalability of the laser systems. Such limitations were not addressed in the conventional technologies due to the fact that the conventional solid-state laser utilizes Grating-Lens combination and Treacy compressor for pulse stretching and compressing. Ideally, in such solid-state systems, all orders of dispersion can be compensated, but the material dispersion can distort and damage this ideal situation. But the material dispersion is not a serious problem in solid-state laser system because the material dispersion is generally considered as not important. However, for a fiber laser system, the situation is different due to the fact that in the fiber laser systems, attempts are made by using the fiber stretcher to replace the grating-lens combination for the purpose of significantly increasing the system reliability. However, the TOD limits the ability for de-chirping when using Treacy compressor since both fiber stretcher and Treacy compressor have positive TOD even this combination can remove the second order dispersion completely. This issue of TOD dispersion makes it more difficult to develop a high-energy fiber laser amplifier with <200 fs pulse width. Actually, the technical difficulty of TOD dispersion is even more pronounced for laser system of higher energy. A laser system of higher energy requires a higher stretch ratio and that leads to a higher TOD. Therefore, for laser system of higher energy, it is even more difficult to re-compress the pulse to the original pulse width.

A chirped Pulse Amplification (CPA) is widely implemented with four parts: a mode-locking (ML) oscillator providing short pulse, a stretcher to get long pulse duration, an amplifier to get high energy, and a compressor to get short pulse and high peak power. In order to obtain a very high peak power, it is required to obtain a high energy and short pulse width at the same time. However, the issue of generating a short pulse width in a fiber laser system is always difficult to achieve due to an uncompensated highly positive third-order dispersion (TOD) generally referred to as the compressibility issue. For the purpose of resolving this compressibility issue, a number of ideas, including new compressor designⁱ and new stretcher are disclosed in different Patent Applications including Patent Applications 06/062,205 and 06/062,905 and the disclosures are hereby incorporated as reference in this Patent Application. In the Application 06/062,906, the self-phase modulation (SPM) was intentionally created and utilized in the stretcher stage in order to reduce the stretcher fiber length and the TOD impact. In addition to above disclosures made by the Applicant of this invention, further improvements to the laser system are still required to resolve this compressibility issue.

In the conventional laser system, the elimination of all nonlinear effects is generally considered as a desirable goal in the conventional design of the high-energy fiber laser system, It was widely believed that the nonlinear effects will degrade the pulse quality and stability. However, in practice, this conventional dogmatic design concept is no longer considered as universally acceptable. A specific example is the use of the Stimulated Raman Scattering (SRS) effects in a fiber Raman amplifier, and nonlinear phase shift accumulated in the amplifier stage was implemented to compensate the TOD. However, in the CPA fiber laser system, the SRS scattering must be avoided. The concept of applying the phase shift and spectral generation for improvement of pulse quality as that disclosed in a fiber Raman amplifier does not provide a direct solution to the difficulties caused by the compressibility issues due to the technical challenges arise from the third order dispersion effects.

Therefore, a need still exists in the art of fiber laser design and manufacture to provide a new and improved configuration and method to provide fiber laser to compensate the dispersion generated in the laser system due to the TOD effects such that the above-discussed difficulty may be resolved.

### SUMMARY OF THE PRESENT INVENTION

It is therefore an aspect of the present invention to provide a laser system with a new compressor that generates a nonlinear phase shift after high energy amplifier to compensate the TOD by introducing self pulse modulation (SPM) to broaden the bandwidth and shorten the bandwidth limited pulse width such that the above-discussed difficulties as that encountered in the prior art may be resolved.

Another aspect of this invention is the capability to provide higher intensity of laser output by generating a nonlinear phase shift by introducing SPM to broaden the bandwidth and shorten the pulse width after the high-energy amplifier because the nonlinear phase shift is able to more effectively compensate higher levels of TOD in a more stabilized way.

Another aspect of this invention is the capability to provide higher intensity of laser output by generating a nonlinear phase shift by introducing SPM to broaden the bandwidth and shorten the pulse width after the high-energy amplifier because the nonlinear phase shift is more controllable for flexibly changing the length of the passive fiber right after the active gain fiber to control the phase shift.

Another aspect of this invention is the capability to provide higher intensity of laser output by generating a nonlinear phase shift by introducing SPM to broaden the bandwidth and shorten the pulse width after the high-energy amplifier because the nonlinear SRS is minimized in the amplification stage that also minimize the nonlinear phase shift in the gain fiber.

Another aspect of this invention is the use of an independent pulse sharper in the compression stage to have a controllable nonlinear phase shift and SPM, and in the meantime keep minimal SRS. The pulse shaper not only can nonlinearly shift the phase, introducing some structure in the spectrum, it can also generate more spectral components coherently. With the SPM induced broadband, the laser system of this invention can achieve much shorter pulse width even with huge TOD.

Briefly, in a preferred embodiment, the present invention discloses a fiber Chirped Pulse Amplification (CPA) laser system that includes a fiber mode-locking oscillator, a fiber stretcher, a multistage amplifier chain, a nonlinear phase shift generator after the amplifier chain and a compressor. In a preferred embodiment, the laser system further includes a pulse shaper right after the amplifier chain.

In a preferred embodiment, this invention further discloses a method for overcoming the drawback in a fiber CPA laser system. The method includes a step of generating a nonlinear phase shift after the pulse is amplified to compensate and reduce the TOD. In a preferred embodiment, the method further includes a step of shaping the pulse right after the pulses are amplified to further improve the controllability of the pulse generation processes.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 is a functional block diagram for showing a fiber laser system implemented with a pulse shaper right after the amplifier chain and a nonlinear phase shift generator in the compressor of this invention.

FIG. 2 shows the time evolution of the laser intensity and the induced nonlinear phase.

FIG. 3A shows the original spectrum and the modified spectrum of the laser pulses, and FIG. 3B shows the amplified spectrum.

FIG. 4A shows autocorrelation traces for the unmodified laser pulses FIG. 4B shows and modified laser pulses.

### DETAILED DESCRIPTION OF THE INVENTION

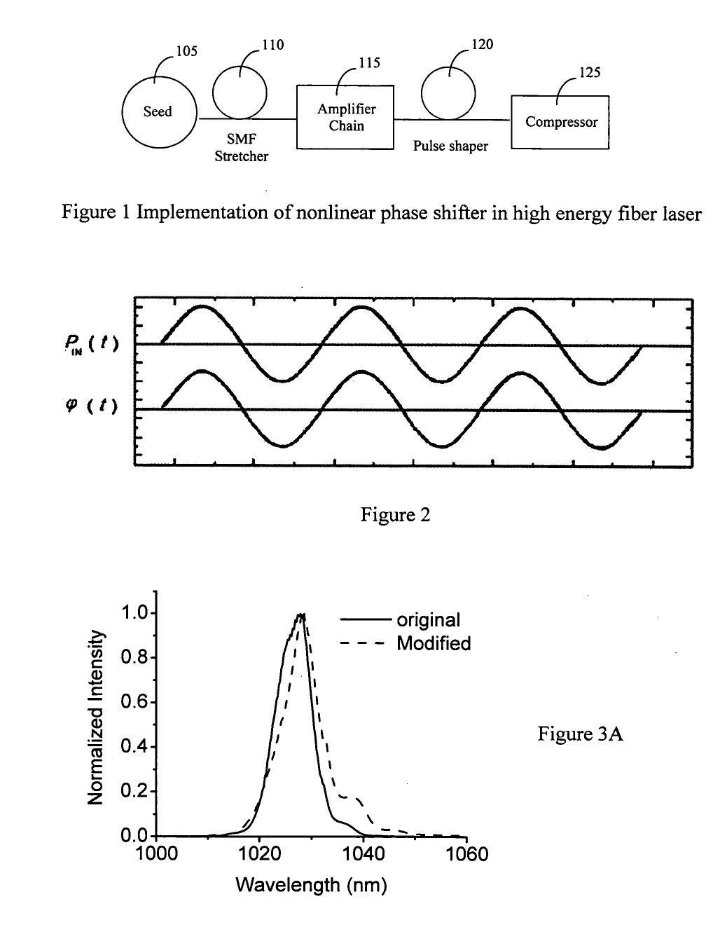

Referring to FIG. 1 for a schematic diagram of a fiber laser system 100 of this invention that implements a dispersion compensator of this invention. The laser system 100 includes a laser seed 105 for generating a seed laser for projecting into a laser stretcher 110 to stretch the laser pulse. The stretcher 110 generates laser pulse with stretched pulse width is projected into a series of laser amplifiers 115 to amplify the laser into higher energy. The amplified laser is then projected into a pulse shaper 120 as a newly added device to the fiber laser system this invention. The pulse-shaped signals are then projected to a compressor 125. The compressor is now implemented with a nonlinear phase generator to generate nonlinear phase shift to compensate and reduce the TOD dispersions and in the meantime recompress the stretched pulse into the original pulse width.

By implementing a nonlinear phase generation in the compressor 125 after the high-energy amplifier to compensate the TOD provide special advantage to significantly shorten the pulse width without being limited by the TOD. By introducing the nonlinear phase shift after the high gain amplifier instead of making use of the nonlinearity spontaneously generated inside the gain fiber of the amplifier presents many advantages. First, after the amplification operation, the laser pulses have higher intensity and higher stability. Therefore, the nonlinear shift generated after the amplification is proportionally increased and is also more stable. The greater nonlinear phase shift offers higher ability to compensate larger TOD in a more stabilized way. Second, compared to the nonlinear phase shift generated inside the amplifier gain fiber, the nonlinear phase shift is more controllable. There are greater flexibilities to change the length of the passive fiber right after the active gain fiber to control the phase shift. Additionally, by implementing an independent pulse shaper 120 to minimize the nonlinear phase shift inside the amplifier chain 115, the SRS is reduced or significantly removed. The laser system as shown in FIG. 1 provides a controllable nonlinear phase shift and SPM, and in the meantime keeps minimal SRS.

The high gain amplifier, e.g., the amplifier chain 115, shown in FIG. 1 utilizes large mode area double cladding fiber. In an exemplary embodiment, the pulse shaper 120 utilizes exact same structure but un-doped fiber to induce the nonlinear phase shift. The pulse shaper is utilized to shape the final pulse by improving the compressibility. The pulse shaper not only can nonlinearly shift the phase, introducing some structure in the spectrum, it can also generate more spectral components coherently. With the SPM induced broadband, the laser system can achieve much shorter pulse width even with huge TOD.

There are two types of nonlinear effects. The first type relates with the interaction of light waves with phonons, such as stimulated Raman scattering and stimulated Brillouin scattering. The second type comes from the intensity dependence of the nonlinear index of the optical fiber. As the high power light passes through the optical fiber, additional phase shift will be added into the phase structure of the light electric field distribution. The nonlinear phase shift can be written as

$${φ}_{NL} = {\vert U ( 0 , T ) \vert}^{2} \cdot \frac{γ {P}_{0}}{α} ( 1 - {ⅇ}^{- α L} ) \\ γ = \frac{2 π}{λ} \cdot \frac{{n}_{2}}{{A}_{eff}} \qquad ( 1 )$$

Where U(0,T) is the normalized initial field amplitude, γ is the nonlinear parameter, n₂ is the nonlinear refractive index, a is the attenuation constant, P₀ is the peak power. When the loss in fiber is negligible, the laser intensity is constant. The nonlinear phase shift is
φ_{NL}=γP₀L (2)

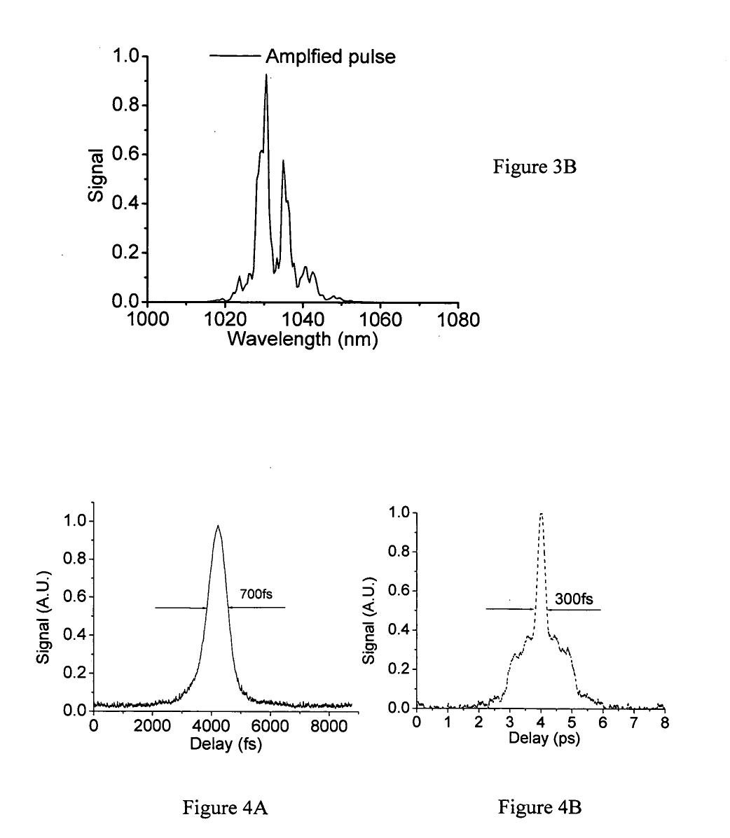

The nonlinear phase shift in Eq. (1) has two direct results. First, the phase resembles the time evolution of the laser intensity, as shown in FIG. 2. It varies with the time; this will generate more spectral components. This leads to the spectral broadening. This phenomenon has been widely demonstrated in the fiber with high to medium intensity laser; with longer fiber, even very low power can generate very wide super continuum radiation. Second, the phase also depends on the frequency. It means that it will generate quite large chirp for the laser pulses. In general, the nonlinear phase induced GVD is positive, and a gating pair can compensate the positive GVD. On the other hand, it also produces negative TOD, which is useful for the TOD issue in the short pulse fiber laser system. The central idea is, we need to tailor the nonlinear phase shift so that the nonlinear TOD is negative and large enough to compensate the positive TOD in the fiber CPA laser system. Since the nonlinear phase has the same spectral shape with the laser intensity, the laser spectrum needs to be modified to generate negative TOD. Experimentally, by modifying the laser spectral shape, we can largely enhance the compressibility of the laser pulses. FIGS. 3 and 4 shows the improvement of laser performance with the tuning of the spectral shape. The amplified laser shape resembles the modified spectral shape, it also shows the SPM structure, it actually benefits the compression.

In an exemplary embodiment that utilizes Yb:fiber laser running at 1030 nm, with a bandwidth of 8 nm, the bandwidth-limited pulse width is around 200 fs; with huge positive TOD, the pulse width can be as long as 700 fs. On one hand, if a nonlinear phase shift is used to compensate the TOD, the pulse width below 300 fs is achieved. However, on the other hand, if the bandwidth is increased to 30 nm, with the same number of TOD, a pulse width below 200 fs is achievable since theoretically the 30 nm bandwidth can support below 50 fs if all orders of dispersion is compensated. The high-energy fiber laser system as shown in FIG. 1 can achieve a laser system capable of generating mJ level sub-200 fs pulses.

According to above descriptions and drawings, this invention discloses a Chirped Pulse Amplification (CPA) fiber laser system. The CPA fiber laser includes a fiber mode-locking oscillator for generating a laser for projecting to a fiber stretcher for stretching a pulse width of the laser. The CPA fiber laser further includes a multistage amplifier for amplifying the laser for projecting into a pulse shaper then to a compressor having a nonlinear phase generator for compensating high order dispersions and compressing the pulse width of the laser. The pulse shaper is further provided to minimize a nonlinear phase shift inside the multistage amplifier for reducing a Stimulated Raman Scattering (SRS). The CPA fiber laser system further provides a controllable nonlinear phase shift and a self phase modulation (SPM). The nonlinear phase generator in the compressor is after the laser is amplified and the nonlinear phase is proportionally increased according to an amplification factor provided by the multistage amplifier. The nonlinear phase generator in the compressor is controllable for generating predefined nonlinear phase shift for adjustably compensating the high order dispersions. In a preferred embodiment, the multistage amplifier further includes a large mode area double cladding fiber. In another preferred embodiment, the pulse shaper further includes an un-doped large mode area double cladding fiber to shape a pulse shape of the laser for improving a compressibility of the laser. The pulse shaper further includes an un-doped large mode area double cladding fiber to introducing spectral components coherent with a broadband laser induced by the SPM for achieving reduce a pulse width of the laser. In a preferred embodiment, the multistage amplifier includes a Yb fiber as a gain medium for a laser having a wavelength substantially 1030 nm with a bandwidth approximately 8 nm having a pulse width around 200 fs. In another preferred embodiment, the laser having a wavelength bandwidth approximately 30 nm for generating an output laser having a pulse width below 200 fs and a power at approximately a mJ level.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A Chirped Pulse Amplification (CPA) fiber laser system comprising:
a fiber mode-locking oscillator for generating a laser for projecting to a fiber stretcher for stretching a pulse width of said laser; and
a multistage amplifier for amplifying said laser for projecting into a pulse shaper then to a compressor having a nonlinear phase generator for compensating high order dispersions and compressing said pulse width of said laser.

2. The CPA fiber laser system of claim 1 wherein:
said pulse shaper is further provided to minimize a nonlinear phase shift inside said multistage amplifier for reducing a Stimulated Raman Scattering (SRS).

3. The CPA fiber laser system of claim 1 wherein:
said CPA fiber laser system providing a controllable nonlinear phase shift and a self phase modulation (SPM).

4. The CPA fiber laser system of claim 1 wherein:
said nonlinear phase generator in said compressor is after said laser is amplified and said nonlinear phase is proportionally increased according to an amplification factor provided by said multistage amplifier.

5. The CPA fiber laser system of claim 1 wherein:
said nonlinear phase generator in said compressor is controllable for generating predefined nonlinear phase shift for adjustably compensating said high order dispersions.

6. The CPA fiber laser system of claim 1 wherein:
said multistage amplifier further comprising a large mode area double cladding fiber.

7. The CPA fiber laser system of claim 1 wherein:
said pulse shaper further comprising an un-doped large mode area double cladding fiber to shape a pulse shape of said laser for improving a compressibility of said laser.

8. The CPA fiber laser system of claim 1 wherein:
said pulse shaper further comprising an un-doped large mode area double cladding fiber to introducing spectral components coherent with a broadband laser induced by said SPM for achieving reduce a pulse width of said laser.

9. The CPA fiber laser system of claim 1 wherein:
said multistage amplifier comprising a Yb fiber as a gain medium.

10. The CPA fiber laser system of claim 1 wherein:
said multistage amplifier comprising a Yb fiber as a gain medium for a laser having a wavelength substantially 1030 nm with a bandwidth approximately 8 nm having a pulse width around 200 fs.

11. The CPA fiber laser system of claim 1 wherein:
said laser having a wavelength bandwidth approximately 30 nm for generating an output laser having a pulse width below 200 fs.

12. The CPA fiber laser system of claim 1 wherein:
said laser having a wavelength bandwidth approximately 30 nm for generating an output laser having a pulse width below 200 fs and a power at approximately a mJ level.
